(19) United States
(12) Patent Application Publication
(10) Pub. No.: US 2005/0201404 A1
(43) Pub. Date: Sep. 15, 2005

(54) Method and apparatus for remote interaction with a computer over a network

(76) Inventors: Jonathan E. Steinhart, McMinnville, OR (US); Michael A. Zuhl, Lake Oswego, OR (US)

Correspondence Address: SMITH-HILL AND BEDELL, P.C., 16100 NW CORNELL ROAD, SUITE 220, BEAVERTON, OR, 97006, US

(21) Appl. No.: 11/029,207

(22) Filed: Jan. 3, 2005

Related U.S. Application Data
(60) Provisional application No. 60/552,230, filed on Mar. 11, 2004.

(51) Int. Cl. H04L 1/00

(52) U.S. Cl. 370/419

(57) ABSTRACT

A remote access device is disclosed for remote interaction with a computer. A local computer transmits graphics data to a remote station over a network. The remote station transmits keyboard and mouse data to the local computer over a network. The remote station can also send control signals unrelated to the keyboard and mouse to the local computer, and can receive local computer state information that is unrelated to the graphics data. The remote access device is a circuit module that is connected to the local computer. This module facilitates the transmission of graphics data, keyboard data, and mouse data.

### CROSS-REFERENCE TO RELATED APPLICATIONS

This application claims benefit of U.S. Provisional Application No. 60/552,230 filed Mar. 11, 2004, the entire disclosure of which is hereby incorporated by reference herein for all purposes.

Subject matter disclosed in this application might be considered to be related to subject matter disclosed in co-pending U.S. patent applications Ser. Nos. ______ and ______ (Attorney Docket ZUHL 2849 and ZUHL 2850), the entire disclosure of each of which is hereby incorporated herein for all purposes.

### BACKGROUND OF THE INVENTION

This invention relates to remote computer access.

The need to access computers from remote locations frequently arises. For example, a system administrator may desire to control a rack of systems from a location other than a noisy or inconveniently secure machine room, or even from home. In addition to keyboard, mouse, and video access, there is a need to remotely monitor the state of various internal signals in computers such as temperature, voltage, and fan speed for diagnostic purposes, and also to control various aspects of computers, for example to remotely reset them, generate system management interrupts, or to set visual indicators.

Early computer architectures made this fairly easy to do. All input and output from the computer could be directed over a single, low-bandwidth console serial interface. A remote display could easily be connected using a long cable or a modem.

Modern computer architectures, most notably the IBM PC architecture, utilize graphical consoles. The output from these computers is high bandwidth analog or digital video which is usually connected to a local video monitor. Serial PS/2 or USB interfaces are used for keyboard and mouse input. These interfaces are not suitable for long distance transmission.

The operation of PC architecture computers takes place in several stages. On power-up, the BIOS displays start-up messages on the console. A number of different configuration dialogs may be entered. A boot loader may be invoked through which the user may select an operating system. The operating system then starts up, generating various messages. A large variety of programs may then be run on top of the operating system. Upon exiting the operating system a number of shut-down messages are displayed on the console.

Several software packages exist that facilitate remote access. Some of these packages use standard networking protocols so that a remote display can be an almost unlimited distance from the computer. However, these packages run on top of the operating system and therefore cannot handle the start-up, configuration, boot loader, operating system start-up, and shut-down messages. Therefore, software packages don't work, for example, in an application where a remote access is desired for system configuration.

Hardware support for remote access exists in the form of keyboard, mouse, and video extension cables and repeaters. KVM (Keyboard, Video, Mouse) switches that allow a single keyboard, mouse, and monitor to be shared by multiple computers are in this category. Some products digitize the signals for transmission over moderately longer but still limited distances. Such hardware does not have the software limitation of requiring the operating system to be running. However, while they allow remote access further from the computer, the distance is effectively limited to hundreds of feet.

There are hardware devices for remote sensing and control of computers. Typically they sense environmental conditions such as temperature and fan speed, and issue reboot or power-off signals. These devices communicate to a remote station over LAN or proprietary communications path; however, these existing remote sensing and control devices do not provide console display and keyboard input over arbitrary distances.

Some computers include internal serial-over-LAN capability that allows some control over a network. These solutions do not provide full functionality, and only provide access during system start-up and shut-down.

### SUMMARY OF THE INVENTION

In accordance with a first aspect of the invention there is provided a remote access device for use with a local computer to allow a remote computer to interact with the local computer, said remote access device comprising a communication interface for receiving encoded control data from the remote computer over a communication medium, a decoder for receiving the encoded control data from the communication interface and generating control signals, a control signal interface for receiving control signals from the decoder, and a computer interface for receiving the control signals from the control signal interface and supplying the control signals to the local computer.

In accordance with a second aspect of the invention there is provided a remote access device for use with a local computer to allow a remote computer to interact with the local computer, said remote access device comprising a computer interface for receiving control signals from the local computer, a control signal interface for receiving the control signals from the computer interface, an encoder for receiving the control signals from the control signal interface and generating encoded control data, and a communication interface for receiving the encoded control data from the encoder and transmitting the encoded control data to the remote computer over a communication medium.

In accordance with a third aspect of the invention there is provided a computer system comprising a local computer having a control signal interface, a remote computer having a processor, a user interface for generating control signals, a processor for receiving the control signals and generating encoded control data, and a communication interface, a remote access device comprising a communication interface for receiving encoded control data, a decoder for receiving the encoded control data from the communication interface and generating a control signal, a local output port for receiving the control signal from the decoder, and a computer interface for receiving the control signal from the local output port and supplying the control signal to the control signal interface of the local computer, and a communication medium for communicating encoded control data from the communication interface of the remote computer to the communication interface of the remote access device, whereby the local computer responds to a control signal generated by the user interface of the remote computer.

In accordance with a fourth aspect of the invention there is provided a computer system comprising a local computer having a status signal interface, a remote access device comprising a computer interface for receiving a status signal from the status signal interface of the local computer, a encoder for receiving the status signal from the computer interface and generating encoded status data, and a communication interface for receiving the encoded status data from the encoder, a remote computer having a communication interface for receiving encoded control data, a decoder for receiving the encoded status data and generating a status signal, and a status signal interface for receiving the status signal from the decoder, and a communication medium for communicating encoded status data from the communication interface of the remote access device to the communication interface of the remote computer, whereby the remote computer responds to the status signal provided by the status signal interface of the local computer.

An embodiment of this invention is a combination input/output device that attaches to a computer. It is indistinguishable from a standard keyboard, mouse, and console output device from the perspective of the computer. Unlike existing devices, the input and output data is in a form suitable for transmission over long haul networks. It also differs from existing devices in that it provides a means for remote monitoring and remote control of the state of internal signals in the computer.

### BRIEF DESCRIPTION OF THE DRAWINGS

FIG. 1 is a schematic block diagram of an embodiment of the invention.

FIG. 2 is a block diagram of the target environment for an embodiment of the invention.

FIG. 3 is a schematic block of the environment for the preferred embodiments of the invention in the target environment.

FIG. 4 is a schematic block diagram of the hardware in the preferred embodiments of the invention. The relationship between the hardware blocks and the blocks shown in FIG. 1 is shown.

FIG. 5 is a schematic block diagram of the firmware in the preferred embodiments of the invention.

### DETAILED DESCRIPTION

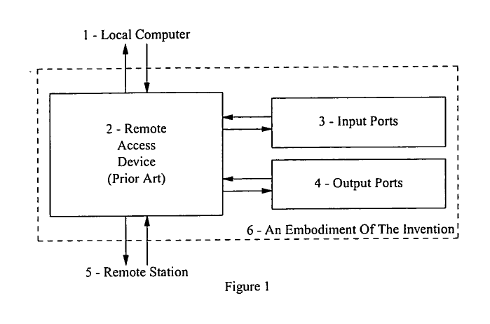

A block diagram of an embodiment of the invention is shown in FIG. 1. An embodiment of the invention 6 connects to a local computer 1 and a remote station 5. The communication between the local computer 1 and the remote station 5 is managed by a remote access device 6 as described in application U.S. patent application Ser. No. ______ (Attorney Docket ZUHL 2849).

A set of input ports 3 and output ports 4 are added to the remote access device 2.

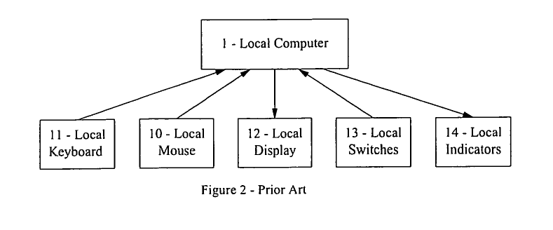

FIG. 2 shows the prior-art target environment for an embodiment of the invention. This environment is a local computer 1 connected to a local keyboard 10, local mouse 11, and local display 12. There may be local switches 13 such as a power switch and reset button. There may also be local indicators 14 such as a power, disk activity, and diagnostic lights. The arrows in FIG. 2 indicate the predominate flow of data; small amounts of control information may flow in the opposite direction.

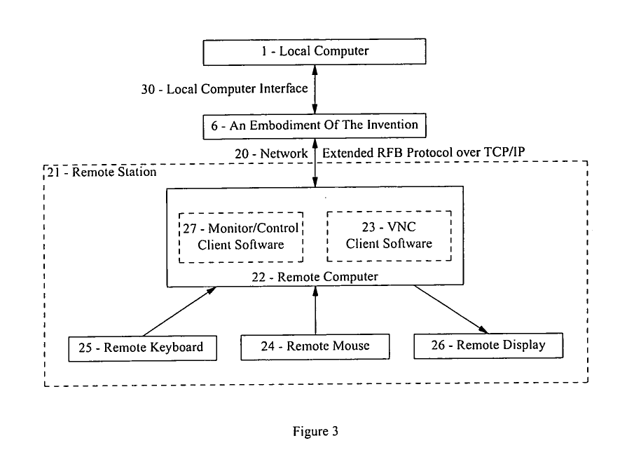

FIG. 3 shows an embodiment of the invention in its target environment. There is no local keyboard 10, local mouse 11, local display 12 attached to the local computer 1. Instead, an embodiment of the invention 7 is connected to the local computer 1 by the local computer interface 30. Local switches 13 may be connected to the output ports 4 through the local computer interface 30. Local indicators 14 may be connected to the input ports 3 through the local computer interface 30.

Keyboard, mouse, and display data are sent to and from a remote station 21 across the network 20. Communication across the network 20 is accomplished by layering the RFB (Remote FrameBuffer) protocol used by the open source VNC (Virtual Network Console) software on top of the TCP/IP protocol. The remote station 21 is a remote computer 22 with a remote keyboard 24, remote mouse 25, and remote display 26. The remote computer 22 includes VNC client software 23. The result is that the remote keyboard 24, remote mouse 25, and remote display 26 appear to the local computer 1 as if they are a local keyboard 10, local mouse 11, and local display 12.

The remote computer 22 also includes monitor/control client software 27 that allows the state of the input ports 3 to be read, and the state of the output ports 4 to be written using extensions to the RFB protocol. Both the VNC client software 23 and monitor/control client software 27 can be operated using the remote keyboard 24, remote mouse 25, and remote display 26.

A single remote station 21 can simultaneously operate multiple instances of an embodiment of the invention 6.

The use of industry standard Ethernet hardware and industry standard TCP/IP protocols allows the remote station 21 to be connected to the computer using commonly available, low cost hardware. The remote station 21 can be anywhere in the world since the TCP/IP protocols are the foundation of the Internet. The use of the RFB protocol and VNC software allow a remote station 21 to be easily constructed using off-the-shelf hardware and software.

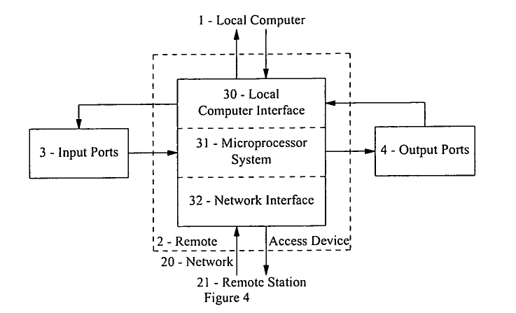

A schematic block diagram of the hardware for the preferred embodiments of the invention is shown in FIG. 4. This diagram adds detail to the overall block diagram in FIG. 1 above.

The remote access device 2 in the preferred embodiments is that which is described in application U.S. patent application Ser. No. ______ (Attorney Docket ZUHL 2849). This remote access device 2 includes a local computer interface 30, network interface 32, and a microprocessor system 31. This embodiment of the invention leverages those components by adding additional functionality rather than duplicating those components.

The addition of the input ports 3 and output ports 4 differentiates this embodiment of the invention from application U.S. patent application Ser. No. ______ (Attorney Docket ZUHL 2849). The inputs to the input ports 3 and the outputs from the output ports 4 connect to the local computer 1 through the local computer interface 30.

Some computer systems have standby power available even when the computer is turned off. An embodiment of the invention can operate from this standby power if it is made available over the local computer interface 30. This enables functionality such as the ability to remotely power on a computer.

An embodiment of the invention communicates with a remote station 21 across the network 20.

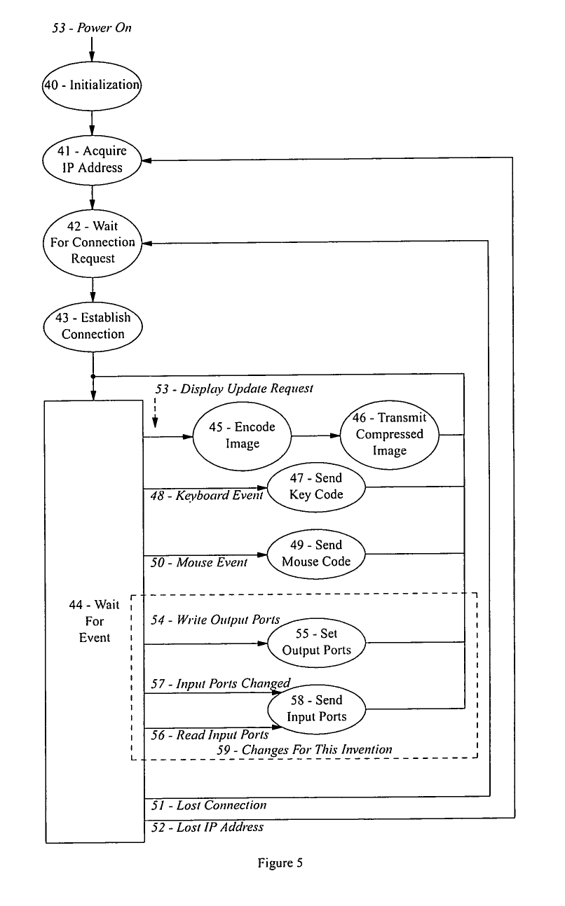

FIG. 5 is a block diagram of the firmware in the preferred embodiments of the invention.

The firmware performs initialization 40 after power on 53.

The initialized system has an Ethernet address set by the network interface 5. It maps that to an IP (Internet Protocol) address in the acquire IP address 41 block. There are several possible ways to acquire an IP address due to the evolution of the Internet. The system tries to acquire an address using DHCP, RARP, and BOOTP.

A remote station 21 can connect to an embodiment the invention once an IP address is established. An embodiment of the invention waits for a request from the remote station 21 in the wait for connection request 42 block.

A connection with the remote station 21 is established in the establish connection 43 block after a connection request is received. This may include handshaking to agree on compression methods and data formats that can be handled by both ends of the connection.

Steady state operation begins once the connection is established. An embodiment of the invention waits for an internal or external event as shown in wait for event 44 and then processes the event. There are eight events:

1. A lost IP address 52, in which case the system goes back to 41 to get a new one,

2. A lost connection 51, in which case the system goes back to 42 to get a new one, or

3. A keyboard event 48 is received from the remote station 21 across the network 20. Send key code 47 translates this event into a key code recognized by the local computer 1 and sends that code to the local computer 1.

4. A mouse event 50 is received from the remote station 21 across the network 20. Send mouse code 49 translates this event into a mouse code recognized by the local computer 1 and sends that code to the local computer 1.

5. A display update request 53 is received from the remote station 21 across the network 20. New image data is sent to the remote station 21. The data is first encoded by encode image 45 and then sent to the remote station 21 by transmit compressed image 46.

6. A write output ports 54 is received from the remote station 21 across the network 20. This causes set output ports 55 to modify the state of the output ports 4.

7. A read input ports 56 is received from the remote station 21 across the network 20. This causes send input ports 58 to transmit the state of the input ports 3 to the remote station 21 across network 20.

8. The wait for event 44 function checks the state of the input ports 3 while waiting. It generates an input ports changed 57 if it detects that the state of the input ports 3 has changed. This causes send input ports 58 to transmit the state of the input ports 3 to the remote station 21 across network 20.

The changes for this invention 59 firmware blocks are the only firmware changes to application U.S. patent application Ser. No. ______ (Attorney Docket ZUHL 2849) required for this embodiment of the invention.

It will be appreciated that the invention is not restricted to the particular embodiment that has been described, and that variations may be made therein without departing from the scope of the invention as defined in the appended claims and equivalents thereof. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated.

1. A remote access device for use with a local computer to allow a remote computer to interact with the local computer, said remote access device comprising:
a communication interface for receiving encoded control data from the remote computer over a communication medium,
a decoder for receiving the encoded control data from the communication interface and generating control signals,
a control signal interface for receiving control signals from the decoder, and
a computer interface for receiving the control signals from the control signal interface and supplying the control signals to the local computer.

2. A remote access device according to claim 1, wherein the communication interface receives encoded switch control data from the remote computer over the communication medium, the decoder receives the encoded switch control data from the communication interface and converts the encoded switch control data to switch control signals, and the remote access device comprises a local output port connected to the computer interface for communicating the switch control signals from the decoder to the local computer for providing the switch control signals to the local computer.

3. A remote access device for use with a local computer to allow a remote computer to interact with the local computer, said remote access device comprising:
a computer interface for receiving control signals from the local computer,
a control signal interface for receiving the control signals from the computer interface,
an encoder for receiving the control signals from the control signal interface and generating encoded control data, and
a communication interface for receiving the encoded control data from the encoder and transmitting the encoded control data to the remote computer over a communication medium.

4. A remote access device according to claim 3, wherein the computer interface receives a local status signal from a local status sensor of the local computer, the remote access device further comprises a local input port connected to the computer interface for communicating the local status signal to the encoder, the encoder converts the local status signal to encoded local status data, and the communication interface receives the encoded local status data and transmits the encoded local status data over the communication medium to the remote computer.

5. A remote access device according to claim 3, wherein the communication interface receives encoded control data from the remote computer over the communication medium, the remote access device comprises a decoder for receiving the encoded control data from the communication interface and generating a control signal, the control signal interface receives the control signal from the decoder, and the computer interface receives the control signal from the control signal interface and supplies the control signal to the local computer.

6. A remote access device according to claim 3, wherein the communication interface receives encoded control data from the remote computer over the communication medium, the remote access device comprises a decoder for receiving the encoded control data from the communication interface and generating a control signal, and the remote access device comprises a local output port connected to the computer interface for receiving the control signal from the decoder and communicating the control signal to the computer interface for providing the control signal to the local computer.

7. A computer system comprising:
a local computer having a control signal interface,
a remote computer having a processor, a user interface for generating control signals, a processor for receiving the control signals and generating encoded control data, and a communication interface,
a remote access device comprising a communication interface for receiving encoded control data, a decoder for receiving the encoded control data from the communication interface and generating a control signal, a local output port for receiving the control signal from the decoder, and a computer interface for receiving the control signal from the local output port and supplying the control signal to the control signal interface of the local computer, and
a communication medium for communicating encoded control data from the communication interface of the remote computer to the communication interface of the remote access device,
whereby the local computer responds to a control signal generated by the user interface of the remote computer.

8. A computer system comprising:
a local computer having a status signal interface,
a remote access device comprising a computer interface for receiving a status signal from the status signal interface of the local computer, a encoder for receiving the status signal from the computer interface and generating encoded status data, and a communication interface for receiving the encoded status data from the encoder,
a remote computer having a communication interface for receiving encoded control data, a decoder for receiving the encoded status data and generating a status signal, and a status signal interface for receiving the status signal from the decoder, and
a communication medium for communicating encoded status data from the communication interface of the remote access device to the communication interface of the remote computer,
whereby the remote computer responds to the status signal provided by the status signal interface of the local computer.
